(19) United States
(12) Patent Application Publication
(10) Pub. No.: US 2023/0320297 A1
(43) Pub. Date: Oct. 12, 2023

(54) SYSTEMS AND METHODS FOR PREVENTING EARLY HARVEST IN AN INDOOR GARDENING APPLIANCE

(71) Applicant: Haier US Appliance Solutions, Inc., Wilmington, DE (US)

(72) Inventor: Jose Rafael Padron, Louisville, KY (US)

(21) Appl. No.: 17/704,184

(22) Filed: Mar. 25, 2022

(51) Int. Cl. A01G 9/24

(52) U.S. Cl. CPC A01G 9/249; A01G 9/246

(57) ABSTRACT

A gardening appliance includes a liner positioned within a cabinet and defining a grow chamber, a grow tower rotatably mounted within the liner, a user interface panel, and a controller. The controller is configured to determine that a harvest prevention mode is activated, detect user interaction with the gardening appliance during the harvest prevention mode, and implement a responsive action in response to detecting the user interaction during the harvest prevention mode, e.g., by providing a user notification and/or performing actions to discourage user interaction.

### FIELD OF THE INVENTION

The present subject matter relates generally to systems for gardening plants indoors, and more particularly, to methods for detecting undesirable interactions with a gardening appliance and performing actions to discourage those undesirable interactions.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

During certain situations, it may be desirable to permit plants to grow uninterrupted from external interaction. For example, it may be desirable to prevent someone from removing a plant prior to a target ripeness or growth level. Alternatively, an appliance owner may wish to periodically prevent tampering with plants. However, conventional gardening appliances do not have systems in place for identifying and preventing undesirable interactions with the appliance or the plants growing therein.

Accordingly, an improved indoor garden center would be useful. More particularly, an indoor garden center with a system and method for detecting undesirable interaction with growing plants and implementing corrective action would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a gardening appliance defining a vertical direction is provided and includes a liner positioned within a cabinet and defining a grow chamber, a grow tower rotatably mounted within the liner, the grow tower defining a root chamber and a plurality of apertures for receiving one or more plant pods, a user interface panel, and a controller in operative communication with the user interface panel. The controller is configured to determine that a harvest prevention mode is activated, detect user interaction with the gardening appliance during the harvest prevention mode, and implement a responsive action in response to detecting the user interaction during the harvest prevention mode.

In another exemplary embodiment, a method of operating a gardening appliance is provided. The gardening appliance includes a liner positioned within a cabinet and defining a grow chamber, a grow tower rotatably mounted within the liner, and a user interface panel. The method includes determining that a harvest prevention mode is activated, detecting user interaction with the gardening appliance during the harvest prevention mode, and implementing a responsive action in response to detecting the user interaction during the harvest prevention mode.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2.

FIG. 4 is a top perspective view of the exemplary gardening appliance of FIG. 1, with a top panel and doors removed according to an exemplary embodiment of the present subject matter.

FIG. 5 is a perspective cross-sectional view of the exemplary gardening appliance of FIG. 1, taken along Line 5-5 from FIG. 2.

FIG. 6 is a top cross-sectional view of the exemplary gardening appliance of FIG. 1, taken along Line 5-5 from FIG. 2.

FIG. 7 provides a perspective view of a grow tower of the exemplary gardening appliance of FIG. 1 according to an exemplary embodiment of the present subject matter.

FIG. 8 provides a method of operating a gardening appliance in a harvest prevention mode according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Referring now to the figures, a gardening appliance 100 will be described in accordance with exemplary aspects of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

According to exemplary embodiments, gardening appliance 100 includes a cabinet 102 that is generally configured for containing and/or supporting various components of gardening appliance 100 and which may also define one or more internal chambers or compartments of gardening appliance 100. In this regard, as used herein, the terms “cabinet,” “housing,” and the like are generally intended to refer to an outer frame or support structure for gardening appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of gardening appliance 100. By contrast, cabinet 102 may enclose some or all portions of an interior of cabinet 102. It should be appreciated that cabinet 102 may have any suitable size, shape, and configuration while remaining within the scope of the present subject matter.

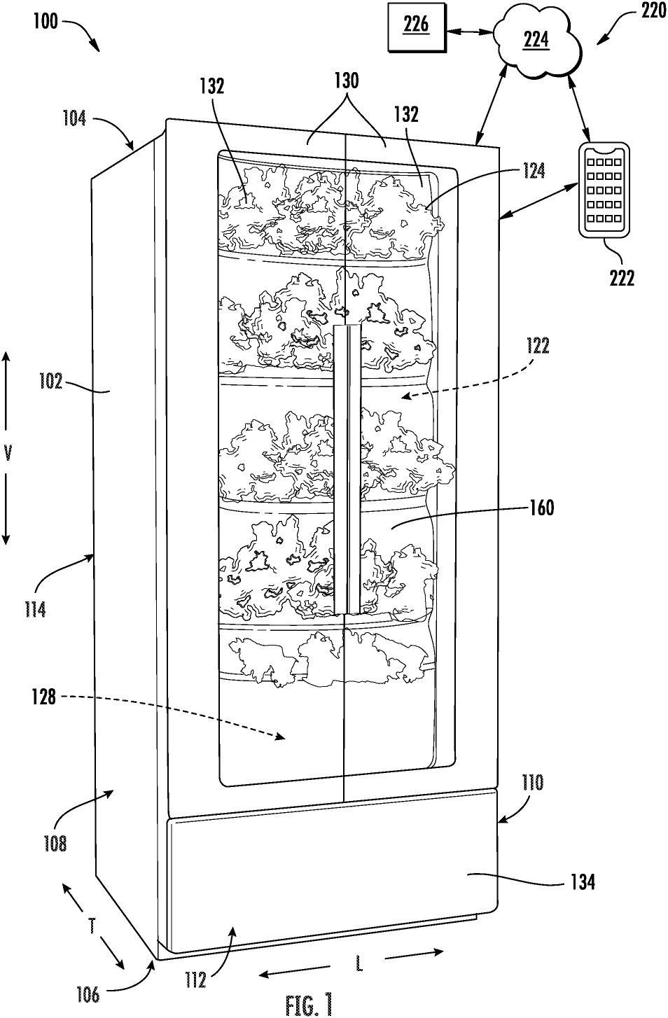

As illustrated, gardening appliance 100 generally defines a vertical direction V, a lateral direction L, and a transverse direction T, each of which is mutually perpendicular, such that an orthogonal coordinate system is generally defined. The horizontal direction is generally intended to refer to a direction perpendicular to the vertical direction V (e.g., within a plane defined by the lateral direction L and the transverse direction T). Cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing gardening appliance 100.

Gardening appliance 100 may include an insulated liner 120 positioned within cabinet 102. Liner 120 may at least partially define an internal temperature-controlled chamber, referred to herein generally as a climate-controlled chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter in any manner.

Cabinet 102, or more specifically, liner 120 may define a substantially enclosed back portion 126 (e.g., proximate rear 114 of cabinet 102). In addition, cabinet 102 and liner 120 may define a front opening, referred to herein as front display opening 128 (e.g., proximate front 112 of cabinet 102), through which a user of gardening appliance 100 may access climate-controlled chamber 122, e.g., for harvesting, planting, pruning, or otherwise interacting with plants 124. According to an exemplary embodiment, enclosed back portion 126 may be defined as a portion of liner 120 that defines climate-controlled chamber 122 proximate rear side 114 of cabinet 102. In addition, front display opening 128 may generally be positioned proximate or coincide with front side 112 of cabinet 102.

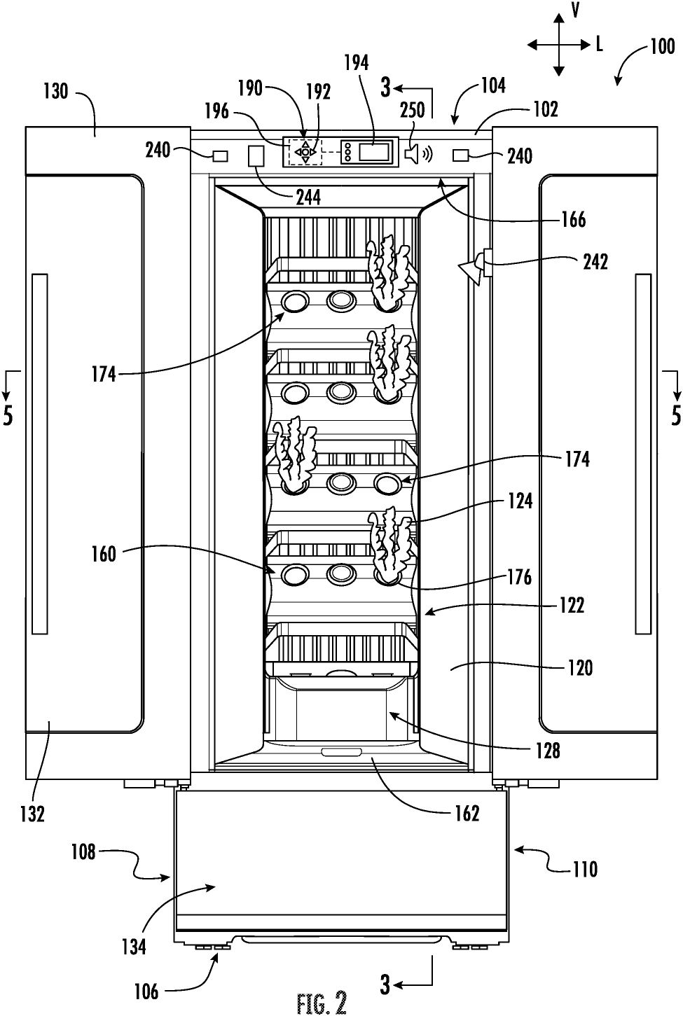

Gardening appliance 100 may further include one or more doors 130 that are rotatably mounted to cabinet 102 for providing selective access to climate-controlled chamber 122. For example, FIG. 1 illustrates doors 130 in the closed position such that they may help insulate climate-controlled chamber 122. By contrast, FIG. 2 illustrates doors 130 in the open positioned to permit access to climate-controlled chamber 122 and plants 124 stored therein. Doors 130 may further include a transparent window 132 through which a user may observe plants 124 without opening doors 130.

Although doors 130 are illustrated as being rectangular and being mounted on front side 112 of cabinet 102 in FIGS. 1 and 2, it should be appreciated that according to alternative embodiments, doors 130 may have different shapes, mounting locations, etc. For example, doors 130 may be curved, may be formed entirely from glass, etc. In addition, doors 130 may have integral features for controlling light passing into and/or out of climate-controlled chamber 122, such as internal louvers, tinting, UV treatments, polarization, etc. One skilled in the art will appreciate that other chamber and door configurations are possible and within the scope of the present subject matter.

According to the illustrated embodiment, cabinet 102 further defines a drawer 134 positioned proximate bottom 106 of cabinet 102 and being slidably mounted to cabinet 102 for providing convenient storage for plant nutrients, system accessories, water filters, etc. In addition, behind drawer 134 is a mechanical compartment 136 for receipt of an environmental control system including a sealed system for regulating the temperature within climate-controlled chamber 122, as described in more detail below.

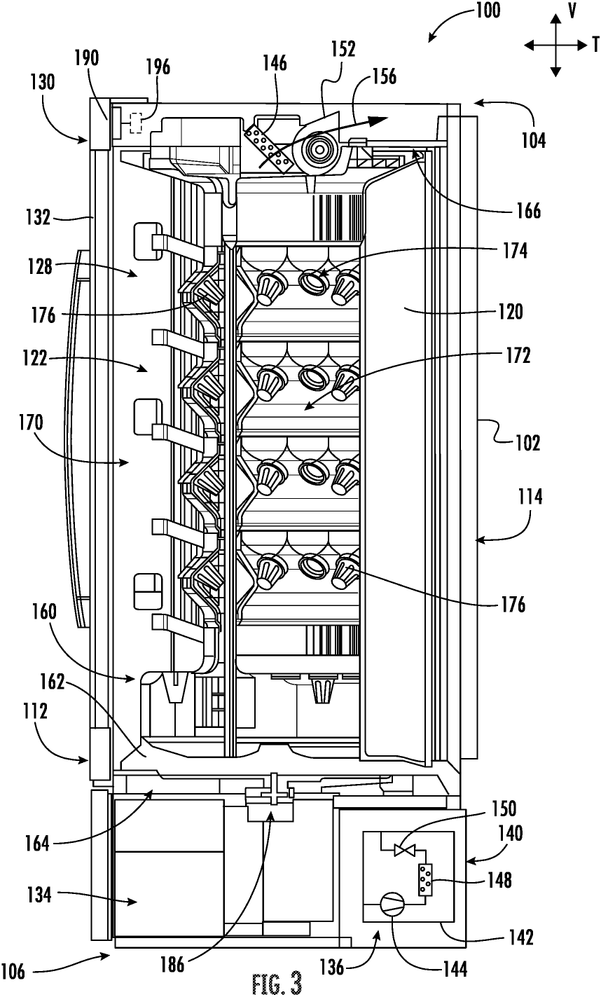

FIG. 3 provides a schematic view of certain components of an environmental control system 140 that may be used to regulate a climate or environment within climate-controlled chamber 122. Specifically, environmental control system 140 may include one or more subsystems for regulating temperature, humidity, hydration, nutrient dosing, lighting, and any other aspects of the environment within one or more portions of climate-controlled chamber 122, e.g., as desired to facilitate improved or regulated growth of plants 124 positioned therein. Although exemplary subsystems and subsystem configurations are described below, it should be appreciated that aspects of environmental control system 140 may vary while remaining within the scope of the present subject matter.

As illustrated, environmental control system 140 includes a sealed system 142 that is generally configured for regulating a temperature and/or humidity within one or more regions of climate-controlled chamber 122. In this regard, as shown schematically in FIG. 3, sealed system 142 may be located partially within mechanical compartment 136 and includes a compressor 144, a first heat exchanger or evaporator 146 and a second heat exchanger or condenser 148. As is generally understood, compressor 144 is generally operable to circulate or urge a flow of refrigerant through sealed system 142, which may include various conduits which may be utilized to flow refrigerant between the various components of sealed system 142. Thus, evaporator 146 and condenser 148 may be between and in fluid communication with each other and compressor 144.

During operation of sealed system 142, refrigerant flows from evaporator 146 and to compressor 144. For example, refrigerant may exit evaporator 146 as a fluid in the form of a superheated vapor. Upon exiting evaporator 146, the refrigerant may enter compressor 144, which is operable to compress the refrigerant and direct the compressed refrigerant to condenser 148. Accordingly, the pressure and temperature of the refrigerant may be increased in compressor 144 such that the refrigerant becomes a more superheated vapor.

Condenser 148 is disposed downstream of compressor 144 and is operable to reject heat from the refrigerant. For example, the superheated vapor from compressor 144 may enter condenser 148 and transfer energy to air surrounding condenser 148 (e.g., to create a flow of heated air). In this manner, the refrigerant condenses into a saturated liquid and/or liquid vapor mixture. A condenser fan (not shown) may be positioned adjacent condenser 148 and may facilitate or urge the flow of heated air across the coils of condenser 148 (e.g., from ambient atmosphere) in order to facilitate heat transfer.

According to the illustrated embodiment, an expansion device or a variable electronic expansion valve 150 may be further provided to regulate refrigerant expansion. During use, variable electronic expansion valve 150 may generally expand the refrigerant, lowering the pressure and temperature thereof. In this regard, refrigerant may exit condenser 148 in the form of high liquid quality/saturated liquid vapor mixture and travel through variable electronic expansion valve 150 before flowing through evaporator 146. Variable electronic expansion valve 150 is generally configured to be adjustable, e.g., such that the flow of refrigerant (e.g., volumetric flow rate in milliliters per second) through variable electronic expansion valve 150 may be selectively varied or adjusted.

Evaporator 146 is disposed downstream of variable electronic expansion valve 150 and is operable to heat refrigerant within evaporator 146, e.g., by absorbing thermal energy from air surrounding the evaporator (e.g., to create a flow of cooled air). For example, the liquid or liquid vapor mixture refrigerant from variable electronic expansion valve 150 may enter evaporator 146. Within evaporator 146, the refrigerant from variable electronic expansion valve 150 receives energy from the flow of cooled air and vaporizes into superheated vapor and/or high-quality vapor mixture. An air handler or evaporator fan 152 is positioned adjacent evaporator 146 and may facilitate or urge the flow of cooled air across evaporator 146 in order to facilitate heat transfer. From evaporator 146, refrigerant may return to compressor 144 and the vapor-compression cycle may continue.

As explained above, environmental control system 140 includes a sealed system 142 for providing a flow of heated air or a flow cooled air throughout climate-controlled chamber 122 as needed. To direct this air, environmental control system 140 may include a duct system 154 for directing the flow of temperature regulated air, identified herein simply as flow of air 156 (see, e.g., FIG. 3). In this regard, for example, evaporator fan 152 can generate a flow of cooled air as the air passes over evaporator 146 and a condenser fan (not shown) can generate a flow of heated air as the air passes over condenser 148.

This temperature-regulated flow of air 156 may be routed through a cooled air supply duct and/or heated air may be routed through a heated air supply duct (not shown). In this regard, it should be appreciated that environmental control system 140 may generally include a plurality of ducts, dampers, diverter assemblies, and/or air handlers to facilitate operation in a cooling mode, in a heating mode, in both a heating and cooling mode, or any other mode suitable for regulating the environment within climate-controlled chamber 122. It should be appreciated that duct system 154 may vary in complexity and may regulate the flows of air from sealed system 142 in any suitable arrangement through any suitable portion of climate-controlled chamber 122.

Although an exemplary sealed system 142 and duct system 154 are illustrated and described herein, it should be appreciated that variations and modifications may be made to sealed system 142 and/or duct system 154 while remaining within the scope of the present subject matter. For example, sealed system 142 may include additional or alternative components, duct system 154 may include additional or different ducting configurations, etc. For example, according to the illustrated embodiment, evaporator 146 and evaporator fan 152 may be positioned at top 104 of cabinet 102 and refrigerant may be routed from mechanical compartment 136 and through cabinet 102 to evaporator 146. In addition, it should be appreciated that gardening appliance 100 may have one or more subsystems integrated with or operably coupled to duct system 154 for filtering the flow of air 156, regulating the concentration of one or more gases within the flow of air 156, etc.

Referring now generally to FIGS. 1 through 7, gardening appliance 100 generally includes a rotatable carousel, referred to herein as a grow tower 160 that is mounted within liner 120, e.g., such that it is within climate-controlled chamber 122. More specifically, grow tower 160 may be positioned on top of a turntable 162 that is rotatably mounted to a sump 164 of gardening appliance 100. In general, grow tower 160 extends along the vertical direction V from sump 164 to a top wall 166 of climate-controlled chamber 122.

In addition, grow tower 160 is generally rotatable about a central axis 168 defined by turntable 162. Specifically, according to the illustrated embodiment, central axis 168 is parallel to the vertical direction V. However, it should be appreciated that central axis 168 could alternatively extend in any suitable direction, e.g., such as the horizontal direction (e.g., defined by the lateral direction L and the transverse direction T). In this regard, grow tower 160 generally defines an axial direction A, i.e., parallel to central axis 168, a radial direction R that extends perpendicular to central axis 168, and a circumferential direction C that extends around central axis 168 (e.g., in a plane perpendicular to central axis 168).

As illustrated, grow tower 160 may generally separate, divide, or partition climate-controlled chamber 122 into a plurality of grow chambers (e.g., identified generally by reference numeral 170). More specifically, grow chambers 170 are generally defined between grow tower 160 and liner 120 or between grow tower 160 and doors 130. In general, grow chambers 170 are intended to support the leafy growth of plants 124 (e.g., or other portions of plants 124 other than the plant roots). According to the illustrated embodiment, grow tower 160 divides climate control chamber 122 into three grow chambers 170, referred to herein generally as a first chamber, a second chamber, and a third chamber. As illustrated, these grow chambers 170 are circumferentially spaced relative to each other and define substantially separate and distinct growing environments. As such, each grow chamber 170 may receive plants 124 having different growth needs and the grow environment within each respective grow chamber 170 may be maintained as grow tower 160 is rotated within climate-controlled chamber 122.

In addition, according to the illustrated embodiment, grow tower 160 may generally define an internal chamber, referred to herein as a root chamber 172. In general, root chamber 172 may be substantially sealed relative to (or isolated from) grow chambers 170 and is configured for containing the roots of plants 124 throughout the growing process. As will be described in more detail below, grow tower 160 may generally define one or more apertures 174 that are defined through grow tower 160 to permit access between grow chambers 170 and root chamber 172. According to exemplary embodiments, these apertures 174 may be configured to receive plant pods 176 into root chamber 172.

Plant pods 176 generally contain seedlings, root balls, or other plant material for growing plants 124 positioned within a mesh or other support structure through which roots of plants 124 may grow within grow tower 160. A user may insert a portion of plant pod 176 (e.g., a seed end or root end) having the desired seeds through one of the plurality of apertures 174 into root chamber 172. A plant end (e.g., opposite the root end) of the plant pod 176 may remain within grow chamber 170 such that plants 124 may grow from grow tower 160 such that they are accessible by a user.

As will be explained below, water and other nutrients may be supplied to the root end of plant pods 176 within root chamber 172. For example, a hydration system may be configured to provide a flow of hydrating mist including water, nutrients, and other suitable constituents for providing the desirable growth environment for plants 124. According to exemplary embodiments, apertures 174 may be covered by a flat flapper seal or seal cap (not shown) to prevent hydrating mist from escaping root chamber 172 when no plant pod 176 is installed and to facilitate improved climate control within root chamber 172 and grow chambers 170. In addition, according to the illustrated embodiment, root chamber 172 may be operably coupled with sealed system 142 for facilitating suitable climate control within the root chamber 172, e.g., to achieve desirable growing conditions.

Although grow tower 160 described and illustrated above includes a single root chamber 172, it should be appreciated that according to alternative exemplary embodiments, grow tower 160 may further include one or more internal dividers (not shown) that are positioned within root chamber 172 to divide root chamber 172 into a plurality of sub-chambers or root chambers. Each of these root chambers may be partially or substantially isolated from the other root chambers to facilitate independent climate control, hydration, gas regulation, etc. In addition, each of these root chambers may be in fluid communication with one of the plurality of grow chambers 170 through the plurality of apertures 174.

Notably, it may be desirable according to exemplary embodiments to form a fluid-tight seal between the grow tower 160 and liner 120. In this manner, as grow tower 160 rotates within climate-controlled chamber 122, grow chambers 170 may remain fluidly isolated from each other. Therefore, according to an exemplary embodiment, grow tower 160 may generally define a grow module diameter (e.g., defined by its substantially circular footprint formed in a horizontal plane). Similarly, enclosed back portion 126 of liner 120 may be substantially cylindrical and may define a liner diameter (not labeled). In order to prevent a significant amount of air from escaping between grow tower 160 and liner 120, and in order to fluidly isolate the various grow chambers 170, the liner diameter may be substantially equal to or slightly larger than the grow module diameter.

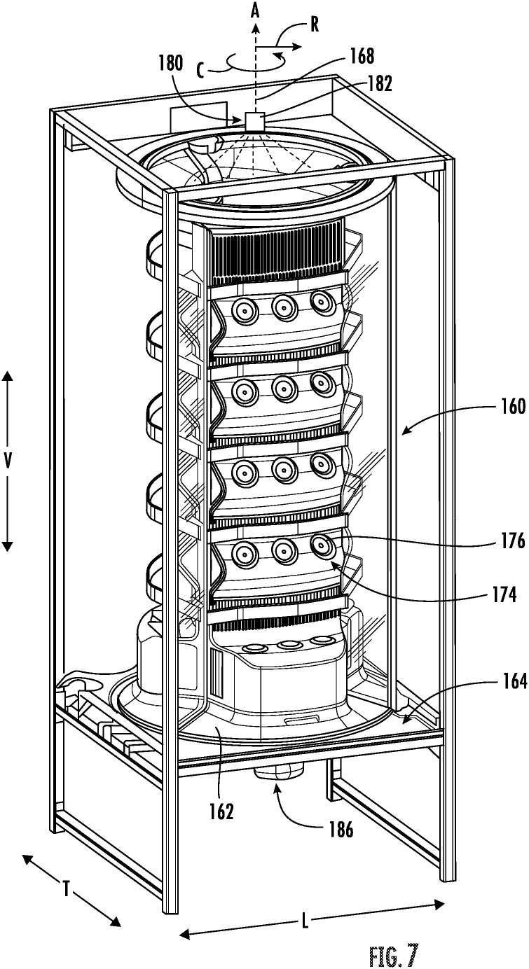

As best shown in FIG. 7, environmental control system 140 may further include a hydration system 180 which is generally configured for providing water and/or nutrients to plants 124 to support their growth. Specifically, according to the illustrated embodiment, hydration system 180 may be fluidly coupled to a water supply and or nutrient distribution assembly to selectively provide desirable quantities and concentrations of hydration, nutrients, and/or other fluids onto plants 124 to facilitate improved plant growth. For example, hydration system 180 includes misting device 182 (e.g., such as a fine mist spray nozzle or nozzles) that is fluidly coupled to a water supply (not shown). For example, the water supply may be a reservoir containing water (e.g., distilled water) or may be a direct connection municipal water supply. According to exemplary embodiments, hydration system 180 may include one or more pumps (not shown) for providing a flow of liquid nutrients to misting device 182. In this regard, for example, water or nutrients that are not absorbed by roots of plants 124 may fall under the force of gravity into sump 164 and these pumps may be fluidly coupled to sump 164 to recirculate the water through misting device 182.

According to the illustrated embodiment, misting device 182 is positioned at a top of root chamber 172 and may be configured for charging root chamber 172 with mist for hydrating the roots of plants 124. Alternatively, misting devices 182 may be positioned at a bottom of root chamber 172 (e.g., within sump 164) for spraying a mist or water into root chamber 172. Because various plants 124 may require different amounts of water for desired growth, hydration system 180 may alternatively include a plurality of misting devices 182, e.g., all coupled to the water supply and/or nutrient supplies. This plurality of misting devices 182 may be spaced apart at along the vertical direction V within root chamber 172. In this manner, these misting devices 182 may provide different concentrations of hydration and/or nutrients to different regions within root chamber 172.

Notably, environmental control system 140 described above is generally configured for regulating the temperature and humidity (e.g., or some other suitable water level quantity or measurement) within one or all of the plurality of chambers 170 and/or root chambers 172 independently of each other. In this manner, a versatile and desirable growing environment may be obtained for each and every chamber 170.

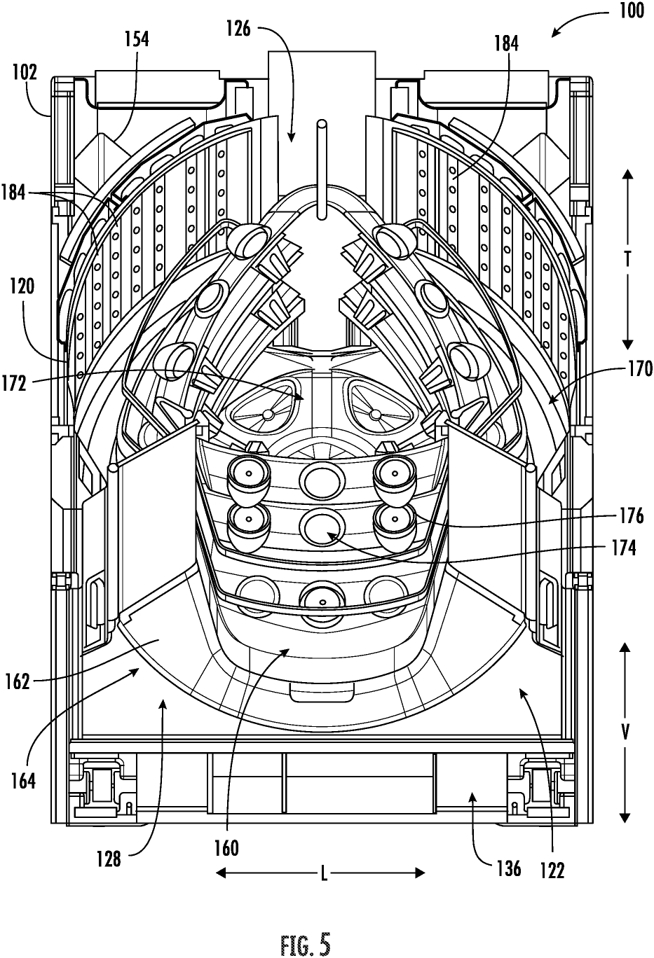

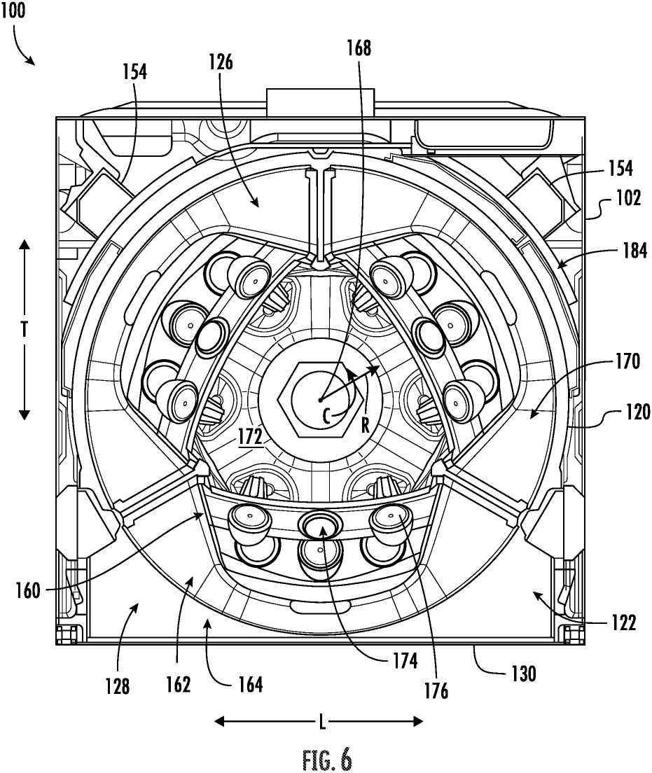

Referring now for example to FIGS. 5 and 6, gardening appliance 100 may further include a light assembly 184 which is generally configured for providing light into selected grow chambers 170 to facilitate photosynthesis and growth of plants 124. As shown, light assembly 184 may include a plurality of light sources (not labeled) stacked in an array, e.g., extending along the vertical direction V. For example, light assembly 184 may be mounted directly to liner 120 within climate-controlled chamber 122 or may alternatively be positioned behind liner 120 such that light is projected through a transparent window or light pipe into climate-controlled chamber 122. The position, configuration, and type of light sources described herein are not intended to limit the scope of the present subject matter in any manner.

Light assembly 184 may include any suitable number, type, position, and configuration of electrical light source(s), using any suitable light technology and illuminating in any suitable color. For example, according to the illustrated embodiment, light assembly 184 includes one or more light emitting diodes (LEDs), which may each illuminate in a single color (e.g., white LEDs), or which may each illuminate in multiple colors (e.g., multi-color or RGB LEDs) depending on the control signal from controller 196. However, it should be appreciated that according to alternative embodiments, light assembly 184 may include any other suitable traditional light bulbs or sources, such as halogen bulbs, fluorescent bulbs, incandescent bulbs, glow bars, a fiber light source, etc.

As explained above, light generated from light assembly 184 may result in light pollution within a room where gardening appliance 100 is located. Therefore, aspects of the present subject matter are directed to features for reducing light pollution, or to the blocking of light from light assembly 184 through front display opening 128. Specifically, as illustrated, light assembly 184 is positioned only within the enclosed back portion 126 of liner 120 such that only grow chambers 170 which are in a sealed position are exposed to light from light assembly 184. Specifically, grow tower 160 acts as a physical partition between light assemblies 184 and front display opening 128. In this manner, as illustrated in FIG. 5, no light may pass from the first or second grow chambers 170 (i.e., the “rear” or enclosed grow chambers 170) through grow tower 160 and out through front display opening 128. As grow tower 160 rotates, two of the three grow chambers 170 will receive light from light assembly 184 at a time. According to still other embodiments, a single light assembly may be used to reduce costs, whereby only a single grow chamber 170 will be illuminated at a single time.

Referring now specifically to FIGS. 3 and 7, gardening appliance 100 may further include a motor assembly 186 or another suitable driving element or device for selectively rotating grow tower 160 during operation of gardening appliance 100. In this regard, according to the illustrated embodiment, motor assembly 186 is positioned below grow tower 160, e.g., within mechanical compartment 136, and may be mechanically coupled to turntable 162 for selectively rotating turntable 162 and grow tower 160 about central axis 168.

As used herein, “motor” may refer to any suitable drive motor and/or transmission assembly for rotating turntable 162 and grow tower 160. For example, motor assembly 186 may include a brushless DC electric motor, a stepper motor, or any other suitable type or configuration of motor. For example, motor assembly 186 may include an AC motor, an induction motor, a permanent magnet synchronous motor, or any other suitable type of AC motor. In addition, motor assembly 186 may include any suitable transmission assemblies, clutch mechanisms, or other components.

Referring again to FIG. 2, gardening appliance 100 may include a control panel 190 that may represent a general-purpose Input/Output (“GPIO”) device or functional block for gardening appliance 100. In some embodiments, control panel 190 may include or be in operative communication with one or more user input devices 192, such as one or more of a variety of digital, analog, electrical, mechanical, or electro-mechanical input devices including rotary dials, control knobs, push buttons, toggle switches, selector switches, and touch pads.

Additionally, gardening appliance 100 may include a display 194, such as a digital or analog display device generally configured to provide visual feedback regarding the operation of gardening appliance 100. For example, display 194 may be provided on control panel 190 and may include one or more status lights, screens, or visible indicators. According to exemplary embodiments, user input devices 192 and display 194 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Gardening appliance 100 may further include or be in operative communication with a processing device or a controller 196 that may be generally configured to facilitate appliance operation. In this regard, control panel 190, user input devices 192, and display 194 may be in communication with controller 196 such that controller 196 may receive control inputs from user input devices 192, may display information using display 194, and may otherwise regulate operation of gardening appliance 100. For example, signals generated by controller 196 may operate gardening appliance 100, including any or all system components, subsystems, or interconnected devices, in response to the position of user input devices 192 and other control commands. Control panel 190 and other components of gardening appliance 100 may be in communication with controller 196 via, for example, one or more signal lines or shared communication busses. In this manner, Input/Output (“I/O”) signals may be routed between controller 196 and various operational components of gardening appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 196 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 196 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 196 may be operable to execute programming instructions or micro-control code associated with an operating cycle of gardening appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 196 as disclosed herein is capable of and may be operable to perform any methods, method steps, or portions of methods as disclosed herein. For example, in some embodiments, methods disclosed herein may be embodied in programming instructions stored in the memory and executed by controller 196.

The memory devices may also store data that can be retrieved, manipulated, created, or stored by the one or more processors or portions of controller 196. The data can include, for instance, data to facilitate performance of methods described herein. The data can be stored locally (e.g., on controller 196) in one or more databases and/or may be split up so that the data is stored in multiple locations. In addition, or alternatively, the one or more database(s) can be connected to controller 196 through any suitable network(s), such as through a high bandwidth local area network (LAN) or wide area network (WAN). In this regard, for example, controller 196 may further include a communication module or interface that may be used to communicate with one or more other component(s) of gardening appliance 100, controller 196, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

According to an exemplary embodiment, motor assembly 186 may be operably coupled to controller 196, which is programmed to rotate grow tower 160 according to predetermined operating cycles, based on user inputs (e.g., via touch buttons 192), etc. In addition, controller 196 may be communicatively coupled to one or more sensors, such as temperature or humidity sensors, positioned within the various chambers 170 for measuring temperatures and/or humidity, respectively. Controller 196 may then operate motor assembly 186 in order to maintain desired environmental conditions for each of the respective chambers 170. For example, as described herein, gardening appliance 100 includes features or subsystems for providing certain locations of gardening appliance 100 with light, temperature control, proper moisture, nutrients, and other requirements for suitable plant growth. Motor assembly 186 may be used to position specific chambers 170 where needed to receive such growth requirements.

According to an exemplary embodiment, such as where grow tower 160 divides climate-controlled chamber 122 into three grow chambers 170, controller 196 may operate motor assembly 186 to index grow tower 160 sequentially through a number of preselected positions. More specifically, motor assembly 186 may rotate grow tower 160 in a counterclockwise direction (e.g., when viewed from a top of grow tower 160) in 120° increments to move chambers 170 between sealed positions and display positions. As used herein, a chamber 170 is considered to be in a “sealed position” when that chamber 170 is substantially sealed between grow tower 160 and liner 120. By contrast, a chamber 170 is considered to be in a “display position” when that chamber 170 is at least partially exposed to front display opening 128, such that a user may access plants 124 positioned within that chamber 170.

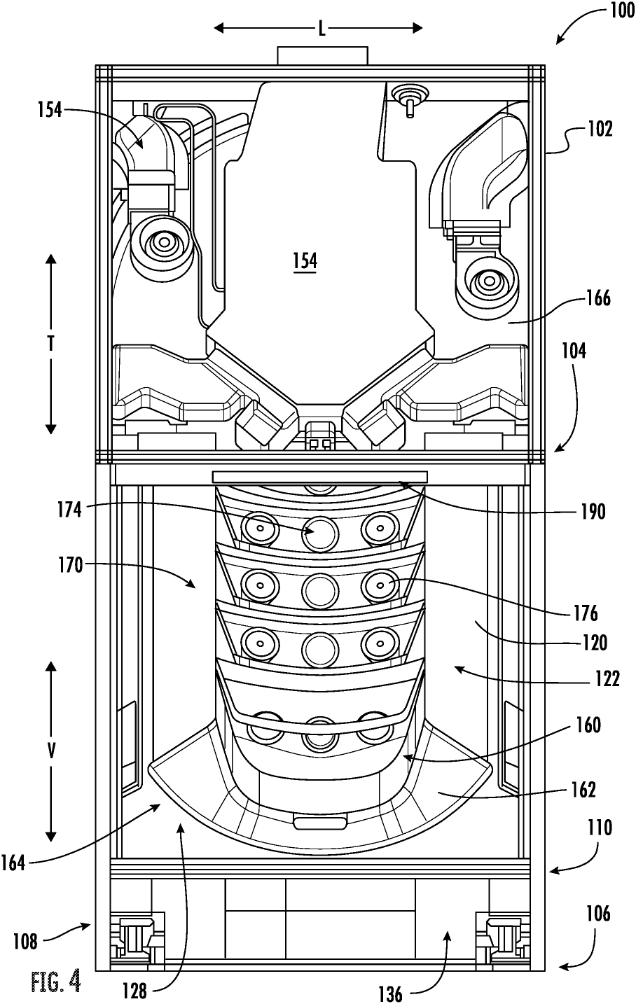

For example, as illustrated in FIGS. 4 and 5, the first grow chamber and the second grow chamber (i.e., the rear chambers) are both in a sealed position, whereas the third grow chamber (i.e., the front chamber) is in a display position. As motor assembly 186 rotates grow tower 160 by 120 degrees in the counterclockwise direction, the second grow chamber will enter the display position, while the first grow chamber and the third grow chamber will be in the sealed positions. Motor assembly 186 may continue to rotate grow tower 160 in such increments to cycle grow chambers 170 between these sealed and display positions.

Gardening appliance 100 and grow tower 160 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow tower 160 that divides the climate-controlled chamber 122 in half to define a first grow chamber and a second grow chamber. According to such an embodiment, by rotating grow tower 160 by 180 degrees about central axis 168, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow tower 160 but may have a modified cabinet 102 such that front display opening 128 is wider and two of the three grow chambers 170 are displayed at a single time. Thus, the first grow chamber may be in the sealed position, while the second grow chamber and the third grow chamber may be in the display positions. As grow tower 160 is rotated counterclockwise, the first grow chamber is moved into the display position and the third grow chamber is moved into the sealed position.

Referring again to FIG. 1, a schematic diagram of an external communication system 220 will be described according to an exemplary embodiment of the present subject matter. In general, external communication system 220 is configured for permitting interaction, data transfer, and other communications between gardening appliance 100 and one or more external devices. For example, this communication may be used to provide and receive operating parameters, user instructions or notifications, performance characteristics, user preferences, or any other suitable information for improved performance of gardening appliance 100. In addition, it should be appreciated that external communication system 220 may be used to transfer data or other information to improve performance of one or more external devices or appliances and/or improve user interaction with such devices.

For example, external communication system 220 permits controller 196 of gardening appliance 100 to communicate with a separate device external to gardening appliance 100, referred to generally herein as an external device 222. As described in more detail below, these communications may be facilitated using a wired or wireless connection, such as via a network 224. In general, external device 222 may be any suitable device separate from gardening appliance 100 that is configured to provide and/or receive communications, information, data, or commands from a user. In this regard, external device 222 may be, for example, a personal phone, a smartphone, a tablet, a laptop or personal computer, a wearable device, a smart home system, or another mobile or remote device.

In addition, a remote server 226 may be in communication with gardening appliance 100 and/or external device 222 through network 224. In this regard, for example, remote server 226 may be a cloud-based server 226, and is thus located at a distant location, such as in a separate state, country, etc. According to an exemplary embodiment, external device 222 may communicate with a remote server 226 over network 224, such as the Internet, to transmit/receive data or information, provide user inputs, receive user notifications or instructions, interact with or control gardening appliance 100, etc. In addition, external device 222 and remote server 226 may communicate with gardening appliance 100 to communicate similar information.

In general, communication between gardening appliance 100, external device 222, remote server 226, and/or other user devices or appliances may be carried using any type of wired or wireless connection and using any suitable type of communication network, non-limiting examples of which are provided below. For example, external device 222 may be in direct or indirect communication with gardening appliance 100 through any suitable wired or wireless communication connections or interfaces, such as network 224. For example, network 224 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 220 is described herein according to an exemplary embodiment of the present subject matter. However, it should be appreciated that the exemplary functions and configurations of external communication system 220 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Now that the construction of gardening appliance 100 has been presented according to an exemplary embodiment, an exemplary method 300 of operating a gardening appliance will be described. Although the discussion below refers to the exemplary method 300 of operating gardening appliance 100, one skilled in the art will appreciate that the exemplary method 300 is applicable to the operation of a variety of other gardening appliances. In exemplary embodiments, the various method steps as disclosed herein may be performed by controller 196 or a separate, dedicated controller.

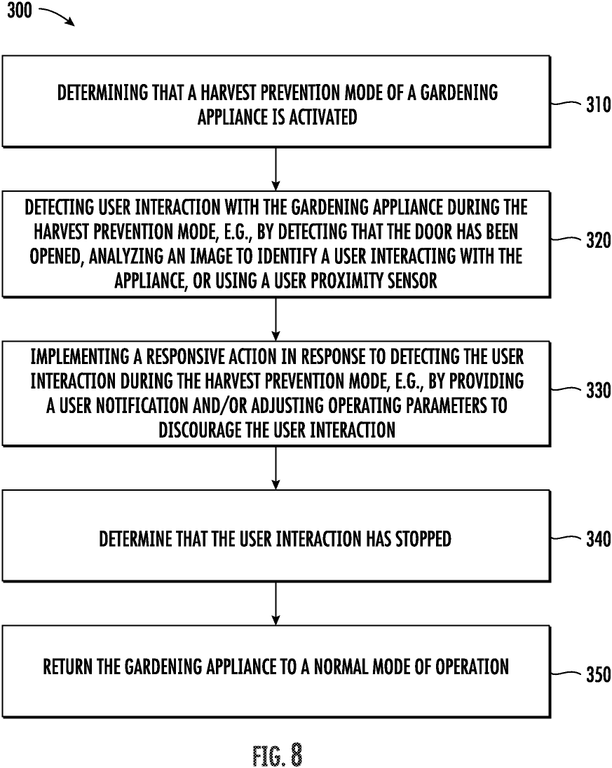

Referring now to FIG. 8, method 300 includes, at step 310, determining that a harvest prevention mode of a gardening appliance is activated. In this regard, using gardening appliance 100 as an example, controller 196 may determine that the appliance is not in a normal mode of operation but is instead operating in the harvest prevention mode. As used herein, the terms “harvest prevention mode” and the like are intended to generally refer to a mode of operation of the gardening appliance where user interaction with one or more specific plants within the gardening appliance is undesirable. In general, normal appliance operation is maintained when harvest prevention mode is activated until undesirable interactions with the appliance are detected, as will be explained in more detail below.

In general, gardening appliance 100 may enter the harvest prevention mode based on any suitable command and under any suitable conditions. For example, according to an exemplary embodiment of the present subject matter, a user may manually request that the appliance enter the harvest prevention mode, e.g., by providing a command through user interface panel 190, through external device 222 via network 224 (e.g., such as a mobile phone), etc. In this regard, the user may simply press a button or provide a command to enter the harvest prevention mode and the appliance may continue operation in that mode until the user manually deactivates the harvest prevention mode, e.g., using similar methods.

According to still other embodiments, controller 196 may be programmed with a schedule for implementing the harvest prevention mode. In this regard, a user may set dates and times during which harvest should be avoided. In addition, or alternatively, controller 196 may use one or more sensors to assess or predict the growth of plants and may automatically designate time periods when users should not interact with the plants. For example, controller 196 may use information such as the time when a particular plant was planted, the type of plant, the hydration and nutrition schedule of the plant, or any other suitable information to determine the state of growth of the plant. Using this information, controller 196 may determine when the harvest prevention mode should be initiated to avoid interaction with the plant.

Although the discussion herein refers to a general implementation of the harvest prevention mode for the appliance, it should be appreciated that this mode of operation may be implemented for a subset of plants or chambers within the gardening appliance. For example, controller 196 may determine that one of the three grow chambers 170 includes plants which should not be interacted with and may implement the harvest prevention mode only with respect to that particular grow chamber 170. Accordingly, the implementation of the harvest prevention method and the steps described below may be performed only when that particular grow chamber is being interacted with. It should be appreciated that other methods of determining that the harvest prevention mode is activated may be used while remaining within the scope of the present subject matter.

While gardening appliance 100 is operating in the harvest prevention mode (e.g., as determined at step 310), step 320 may generally include detecting user interaction with the gardening appliance during the harvest prevention mode. In this regard, gardening appliance 100 may include a variety of sensors, cameras, and other devices/features for determining when a user is attempting to interact with gardening appliance 100 or plants located therein while the harvest prevention mode is activated. Although exemplary sensors and associated methods of detecting user interactions are provided below, it should be appreciated that these examples are only intended to facilitate discussion of aspects of the present subject matter. Other suitable sensors and detection methods are possible and within the scope of the present subject matter.

According to an exemplary embodiment, gardening appliance 100 may further include a door sensor 240 (e.g., as illustrated in FIG. 2) for detecting the position of doors 130. In this regard, door sensor 240 may be any suitable device for detecting the position of doors, such as a mechanical switch, an electrical contact, a hall effect sensor and magnet, an optical sensor, or any other suitable sensor or device intended to detect the position of doors 130. Accordingly, step 320 of detecting the user interaction may include determining that the door of the appliance has been opened using the door sensor.

According to another exemplary embodiment, gardening appliance 100 may further include a camera assembly 242 that is generally configured for obtaining images within or around gardening appliance 100. For example, as shown in FIG. 2, camera assembly 242 may be mounted to cabinet 102 proximate front display opening 128. Camera assembly 242 may have a field of view that includes plants 124, grow tower 160, and/or the entirety of front display opening 128. In this manner, if an external object (e.g., a human hand) attempts to interact with plants 124 or grow tower 160, camera assembly 242 may obtain images or video of this attempted interaction. In this regard, for example, anytime doors 130 are open, camera assembly 242 may obtain images that are analyzed (e.g., using an artificial intelligence or machine learning image recognition process or any other suitable image recognition technology) to detect the presence of a human hand or another object attempting to interact with plants 124.

According to still other embodiments, gardening appliance 100 may include a user proximity sensor 244 (e.g., as shown schematically in FIG. 2). In general, user proximity sensor 244 may include any suitable device or sensor that is configured to detect the presence of a user or another object. For example, user proximity sensor 244 may include at least one of an infrared sensor, an optical sensor, an acoustic sensor, an electromagnetic sensor, or a chemical sensor. In addition, or alternatively, user proximity sensor 244 may be a wireless communication module that detects the presence of a user’s mobile device as it approaches gardening appliance 100. Other suitable user proximity sensors are possible and within the scope of the present subject matter.

After determining that the harvest prevention mode is activated (e.g., at step 310) and detecting user interaction while the harvest prevention mode is activated (e.g., at step 320), step 330 may generally include implementing a responsive action in response to detecting the user interaction during the harvest prevention mode. According to exemplary embodiments, this responsive action may include providing a user notification that the user interaction has been detected during harvest prevention mode. This user notification may be provided to the owner of the appliance or another party that is in control of plant growth. In addition, this user notification may be provided in any suitable manner, e.g., such as through a message on the display of the user interface panel 190 or through communication with a remote device. For example, the user notification may be provided to the user through the user’s mobile phone (e.g., external device 222) in the form of a text message, an email, a push notification, or any other suitable communication. In general, this user notification is intended to inform the user of the undesirable interaction with gardening appliance 100 and permit a user to take corrective action.

In addition, or alternatively, step 330 of implementing the responsive action may include adjusting at least one operating parameter of gardening appliance 100 to discourage the user interaction. In this regard, for example, gardening appliance 100 may take any suitable control actions that notify the user that the attempted interaction is undesirable and that the appliance is operating in a harvest prevention mode or which may otherwise discourage further interaction or engagement with gardening appliance 100. Although exemplary operating parameter adjustments are described below, it should be appreciated that gardening appliance 100 may include other features that may be adjusted to discourage user interaction during the harvest prevention mode.

According to an exemplary embodiment, user interface panel 190 of gardening appliance 100 may further include a speaker 250 (e.g., as shown for example in FIG. 2). According to an exemplary embodiment, adjusting the at least one operating parameter of the gardening appliance to discourage the user interaction may include generating an audible alarm or warning using the speaker 250. In this regard, speaker 250 may communicate a message that the appliance is in harvest prevention mode and that interaction with the plants is prohibited. According to an exemplary embodiment, the audible alarm may further include a warning beep, acoustic indicator, or any other suitable audible warning.

According to an exemplary embodiment, user interface panel 190 may further include display 194 (e.g., as shown for example in FIG. 2). According to an exemplary embodiment, adjusting the at least one operating parameter of the gardening appliance to discourage the user interaction may include flashing the display or displaying a warning message using display 194. For example, the display 194 may flash, internal light assemblies 184 may blink, or any other sequence of illumination may be provided to discourage the user from interacting with the appliance. It should be appreciated that manipulation of light assemblies may be performed independently of or simultaneously with the audible indicators described above.

According to still another exemplary embodiment, adjusting the at least one operating parameter of the gardening appliance may include operating motor assembly 186 to selectively rotate grow tower 160 in a manner that discourages user interaction. For example, when user interaction is detected, motor assembly 186 may vibrate or oscillate grow tower 160, may rotate grow tower 160 to conceal plants that correspond to the harvest prevention mode, or may otherwise move plants out of reach of the user when interaction is undesirable. It should be appreciated that this rotation or movement of grow tower 160 may be performed independently of or simultaneously with the audible and visible indicators described above.

Notably, it may be desirable to reenter normal operation when the harvest prevention mode is no longer active or needed. Accordingly, step 340 may include determining that the user interaction has stopped and step 350 may include returning the gardening appliance to a normal mode of operation. In this regard, the responsive actions intended to discourage user interaction may cease when a user is no longer near gardening appliance 100 or is no longer attempting to interact with gardening appliance 100. In addition, when the harvest prevention mode ends (e.g., via user command or at the end of a scheduled time period), controller 196 may operate in a normal mode of operation (e.g., without discouraging user interaction).

FIG. 8 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 300 are explained using gardening appliance 100 as an example, it should be appreciated that this method may be applied to the operation of any other suitable gardening appliance.

As explained herein, aspects of the present subject matter are generally directed to a method for prevent early harvesting in an indoor plant grower. For example, the growing appliance could be put in special mode for early harvest prevention using the user interface panel, a cloud-based communication, a mobile software application, etc. Sensors such as door open sensor, a camera, or a proximity or presence sensor may be used for detecting human interaction. When the special mode is enabled, the owner of the product may be notified when someone is accessing the growing area through text messages, email, push notifications on a mobile phone, through an audible alarm, etc. While interaction is still in progress, the growing appliance may run special logic to discourage the person from continuing to use the unit, e.g., by means of continuously blink display lights, continuously play audible alarm sound, continuously moving the tower out of front position (left to right, clockwise, or counterclockwise) to make plants inaccessible or hard to reach, etc. The growing appliance may return to normal mode when human interaction stops or special mode is disabled.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gardening appliance defining a vertical direction, the gardening appliance comprising:
a liner positioned within a cabinet and defining a grow chamber;
a grow tower rotatably mounted within the liner, the grow tower defining a root chamber and a plurality of apertures for receiving one or more plant pods;
a drive motor for selectively rotating the grow tower;
a user interface panel; and
a controller in operative communication with the user interface panel, the controller being configured to:
determine that a harvest prevention mode is activated;
detect user interaction with the gardening appliance during the harvest prevention mode; and
implement a responsive action in response to detecting the user interaction during the harvest prevention mode, wherein implementing the responsive action to discourage the user interaction comprises rotating the grow tower to avoid the user interaction or move plants out of reach.

2. The gardening appliance of claim 1, wherein determining that the harvest prevention mode is activated comprises:
receiving a command from a user to enter the harvest prevention mode or following a schedule programmed into the controller.

3. The gardening appliance of claim 1, further comprising a door pivotally mounted to the cabinet for providing selective access to the grow chamber and a door sensor, wherein detecting the user interaction comprises:
determining that the door has been opened using the door sensor.

4. The gardening appliance of claim 1, further comprising a camera assembly, wherein detecting the user interaction comprises:
obtaining one or more images using the camera assembly; and
analyzing the one or more images to identify a user interacting with the gardening appliance.

5. The gardening appliance of claim 1, further comprising a user proximity sensor, and wherein detecting the user interaction comprises:
determining that a user is proximate the gardening appliance using the user proximity sensor.

6. The gardening appliance of claim 5, wherein the user proximity sensor comprises at least one of an infrared sensor, an optical sensor, an acoustic sensor, an electromagnetic sensor, or a chemical sensor.

7. The gardening appliance of claim 1, wherein implementing the responsive action comprises:
providing a user notification that the user interaction has been detected during the harvest prevention mode.

8. The gardening appliance of claim 7, wherein the user notification is provided through the user interface panel.

9. The gardening appliance of claim 7, wherein the controller is in operative communication with a remote device through an external network, and wherein the user notification is provided through the remote device.

10. The gardening appliance of claim 9, wherein the user notification comprises at least one of a text message, an email, or a push notification.

11. The gardening appliance of claim 1, wherein implementing the responsive action comprises:
adjusting at least one operating parameter of the gardening appliance to discourage the user interaction.

12. The gardening appliance of claim 11, wherein the user interface panel further comprises a speaker, and wherein adjusting the at least one operating parameter of the gardening appliance to discourage the user interaction comprises:
generating an audible alarm using the speaker.

13. The gardening appliance of claim 11, wherein the user interface panel comprises a display, and wherein adjusting the at least one operating parameter of the gardening appliance to discourage the user interaction comprises:
flashing the display or displaying a warning message.

14. (canceled)

15. The gardening appliance of claim 11, wherein the controller is further configured to:
determine that the user interaction has stopped; and
return the gardening appliance to a normal mode of operation.

16. A method of operating a gardening appliance, the gardening appliance comprising a liner positioned within a cabinet and defining a grow chamber, a grow tower rotatably mounted within the liner, a drive motor for selectively rotating the grow tower, and a user interface panel, the method comprising:
determining that a harvest prevention mode is activated;
detecting user interaction with the gardening appliance during the harvest prevention mode; and
implementing a responsive action in response to detecting the user interaction during the harvest prevention mode, wherein implementing the responsive action to discourage the user interaction comprises rotating the grow tower to avoid the user interaction or move plants out of reach.

17. The method of claim 16, wherein detecting the user interaction comprises:
determining that a door has been opened using a door sensor.

18. The method of claim 16, wherein detecting the user interaction comprises:
determining that a user is proximate the gardening appliance using a user proximity sensor.

19. The method of claim 16, wherein implementing the responsive action comprises:
providing a user notification that the user interaction has been detected during the harvest prevention mode.

20. The method of claim 16, wherein implementing the responsive action comprises at least one of generating an audible alarm or flashing a display or displaying a warning message .

21. The gardening appliance of claim 1, wherein implementing the responsive action to discourage the user interaction comprises vibrating or oscillating the grow tower to avoid the user interaction.
